(19) United States
(12) Patent Application Publication
(10) Pub. No.: US 2014/0183989 A1
(43) Pub. Date: Jul. 3, 2014

(54) LAMINATED CORE ASSEMBLY

(71) Applicant: Gerhard Lenschow, Aurich (DE)

(72) Inventor: Gerhard Lenschow, Aurich (DE)

(73) Assignee: Wobben Properties GmbH, Aurich (DE)

(21) Appl. No.: 14/007,934

(22) PCT Filed: Mar. 28, 2012
(86) PCT No.: PCT/EP2012/055530

§ 371 Date: Dec. 4, 2013

(30) Foreign Application Priority Data
Apr. 1, 2011 (DE) 10 2011 006 680.2

(51) Int. Cl. H02K 9/22; H02K 15/04; H01F 41/02; H02K 9/02; H02K 3/34; H02K 1/20

(52) U.S. Cl. CPC H02K 9/22; H02K 3/345; H02K 1/20; H01F 41/02; H02K 9/02; H02K 15/04
USPC 310/54; 310/52; 310/58; 290/55; 290/1 B; 29/596

(57) ABSTRACT

The invention relates to a laminated core assembly of an electric generator, in particular of a generator of a gearless wind turbine. The laminated core assembly comprises at least one laminated core, at least one winding arranged around the laminated core, and an electrical insulating means arranged between the laminated core and the winding, wherein the insulating means has a composite material for conducting the heat arising in the winding.

### BACKGROUND

1. Technical Field

The present invention relates to a laminated core assembly of an electric generator, in particular of a generator of a gearless wind turbine. The present invention relates further to an electric generator, in particular of a gearless wind turbine, as well as to a wind turbine. Furthermore, the present invention relates to a method for manufacturing a laminated core assembly.

2. Description of the Related Art

A pole shoe generally serves the purpose of leading a magnetic field and of

letting the magnetic field lines exit in a defined form and distributing them. Such a pole shoe consists of a material with a high permeability. In an electric generator of a gearless wind turbine, pole shoes are, for example, located in the stator and/or in the rotor of the generator. In the following, pole shoe will mean a laminated pole shoe core, which, to prevent or to at least reduce eddy currents, is constructed of a number of different sheet metal lamellas, isolated from each other. The same applies to the laminated cores of a stator, namely, in particular, the bridges in the grooves that hold a winding.

One option for increasing the output of a generator of a gearless wind turbine is to increase the excitation current, i.e., the current that flows through the excitation winding and, in this process, creates a magnetic field. This increases the thermal stress on the windings and insulations arranged on the individual laminated pole shoe cores and, as a consequence, may lead to damage at the laminated pole shoe core due to overheating. In order to prevent such damage, air cooling, water cooling or combined air-water cooling systems are generally known for such generators. Some of these above mentioned solutions have a very low cooling performance or are time and cost extensive, since they require changes to the design of the generator. In particular, the assembly of a cooling system to be mounted at the rotor of a synchronous generator with salient pole rotors, as it is used in a gearless wind turbine, requires great constructional efforts. In such case, the excitation windings are distributed separately to individual winding cores across the circumference.

### BRIEF SUMMARY

One or more embodiments of the present invention are directed to solving, or at least to reducing, at least one of the above-described problems. In particular, an improved heat release of a laminated core assembly of an electric generator, in particular of a gearless wind turbine, is enabled.

In one embodiment a laminated core assembly of an electric generator, in particular of a generator of a gearless wind turbine, comprises at least one laminated core, in particular a laminated pole shoe core, at least one winding arranged around the laminated core, and an electrical insulating means arranged between the laminated core and the winding, wherein the insulating means has a composite material for conducting the heat arising in the winding. In the following, composite material includes a material having two or more materials combined with each other. A composite material may be a fiber composite material or respectively fiber composite plastic that includes a surrounding matrix and reinforced fibers. As fibers, for example glass fibers, aramid fibers or natural fibers, such as cellulose fibers, can be used. Preferably, the fibers have the form of a flat textile fabric, i.e., the form of non-woven material. Alternatively, fibers can also have the form of a woven fabric or a multi-ply weave. The matrix can, for example, comprise thermosets such as synthetic resins, elastomers or thermoplastics. Preferably, epoxy resins or silicone resins are used.

A laminated core assembly comprises a laminated core and further elements. The laminated core can be a laminated pole shoe core of a rotor or a laminated stator core of a stator. All explanations provided in the context of the laminated pole shoe core apply accordingly also to the laminated stator core and vice versa.

An example of such a composite material is a resin impregnated paper, where the resin is preferably in a so-called B-stage, i.e., a stage, where the material has already been treated, for example with heat, but has not been finally cured yet. Thus, the resin is still able to react and accordingly is able to be treated further.

Furthermore, the composite material may comprise a particulate composite. In the following, particulate composite means a composite material in the matrix of which particles of other elements are embedded. Such elements may, for example, be ceramic particles, particles of high melting point metals or other metals, or particles of hard materials.

The advantages of the use of such an insulating means made of composite material are the high electrical insulation capacity as well as the good thermal conductivity.

Preferably, the insulating means has a paper, in particular an aramid paper, and another resin impregnated layer of material arranged on the paper, in particular a glass fiber non-woven material. Together, the paper and the resin impregnated layer of material form a composite material. Such insulating means are electrically non-conductive and therefore serve the purpose of electrical insulation. However, they do have a good thermal conductivity and therefore are able to, at least partially, conduct the heat arising in the winding, for example into the laminated core. Through the application of, for example, a resin impregnated glass fiber non-woven material, air entrapment is prevented, or at least reduced. The good suction effect of the non-woven material generates an optimal capillary action, i.e., the filling of cavities. In addition, the strength of the composite material is increased, and a strong (tight) adhesive bond is created between the insulating paper and the adjacent laminated core.

Through the use of a composite material, a part of the matrix can settle in small pores and gaps, particularly in pores and gaps on the surface of the laminated core. Thus, air entrapment can be prevented and, therefore, the heat transfer from the winding to the laminated core can be improved. The use of composite material makes it possible to provide an amount of matrix sufficient for the above, which could not be provided by an insulating paper.

Such a non-woven material can have different fibers. Preferably, glass fibers are used. Alternatively, fibers made of cellulose, polyamide, polyester, aramid and the like may be used. Through the use of such non-woven material, the overall thickness of the composite material can be minimized. The thickness of such a non-woven material ranges from a few μm up to 50μ or up to 100μ. Such a thin material leads to an increase of the thermal conductivity as compared to thicker materials.

Alternatively, insulating paint, on which merely a resin impregnated non-woven material is arranged, can be used as insulating means. In this case, the paper is omitted. The advantage of this is that the thickness of the material is reduced and that thus the thermal conductivity is increased.

In another preferred embodiment of the laminated core assembly according to the insulating means comprises ceramic particles. Such ceramic particles are added to the material mix in the form of nanoparticles. The ceramic particles support the electrical insulation as well as the conduction of heat from the winding to, for example, the laminated core. The ceramic particles might support the flow process.

Such a matrix material that is provided with ceramic particles, in particular a resin, is applied, for example, on a paper to increase the thermal conductivity. The ceramic particles can, for example, be made of aluminum oxide, silicon carbide, zirconium oxide, silicon dioxide and the like.

As an alternative or in addition to the ceramic particles, mica, such as common mica, brittle mica or synthetic mica can be added to the resin.

According to one embodiment, it is proposed that the at least one laminated core has a heat sink, entirely or partially surrounding the laminated core, wherein the heat sink is arranged between the laminated core and the winding. This leads to a close thermal contact between the heat sink and the heat source, i.e., the winding, and the heat source is cooled directly. Thus, the heat is conducted before the occurrence of overheating in order to prevent damage to the insulation and the winding. Heat arising in the laminated core, e.g., through the loss of eddy currents and loss of iron, can also flow from the laminated core to the heat sink and be conducted in a simple manner.

Preferably, the insulating means is arranged between the winding and the heat sink. Thus, the heat sink, which is formed for example of aluminum, electrically insulates against the winding and the heat can be conducted from the winding to the heat sink.

Preferably, such a heat sink has a smooth surface. Thus, a layer of material, for example the paper, can be omitted in the insulating means, and, for example, a resin impregnated non-woven material can be used.

In a preferred embodiment of the laminated core assembly according to the invention, the heat sink has connections, wherein the connections are entirely or partially integrated into a laminated core assembly. Such an integration is, for example, performed in such way that the corners of the laminated core are left open and that the connections are arranged in this area so that the space left open or respectively saved is used efficiently. Thus, the connections can assume the position of corners or respectively edges of a laminated pole shoe core and, thus, be integrated in the form of the laminated core assembly.

Preferably, the invention comprises an electric generator, in particular of a gearless wind turbine, with a rotor and a stator, wherein the rotor and/or stator has at least one laminated core assembly. The rotor comprises a rotor belt and/or the stator a stator belt, which respectively comprise a cooling channel for transporting a coolant, in particular a cooling fluid. The term rotor belt refers to a circumferential bearing ring of the rotor with a defined radius, which bears the laminated cores, namely, in this case, the laminated pole shoe cores. Accordingly, the term stator belt refers to a circumferential bearing ring of the stator with a defined radius, which can also be referred to as stator ring.

Via the insulating means, the heat, which is mostly generated by the winding, is, at least partially, conducted into the laminated core and from there into the cooling channel. Preferably, a cooling fluid, in particular water with a part of glycol, flows through such a cooling channel. The cooling channel is part of a closed cooling circuit, where the cooling fluid, which is warmed up due to the heat release at the laminated core, is cooled again.

According to another embodiment of the invention, the rotor and/or the stator of the electric generator respectively comprise at least two laminated cores, wherein each laminated core comprises one heat sink or respectively one of the heat sinks and all heat sinks are functionally connected by at least one cooling channel. The heat sink is located between the laminated core and the winding and thus directly cools the laminated core.

Preferably, the rotor of the electric generator comprises emergency air cooling, where, for example in a stator bell, air is pressed into the generator by means of a fan, where, for cooling, amongst other things, it can be fed through the generator air gap between the rotor and the stator. During normal operating conditions, the fan is operated at the slowest speed possible. In the case of a failure of the regular cooling system, the speed of the fan is increased to provide more cooling air.

Furthermore, according to the invention a wind turbine with an electric generator according to the invention is proposed, wherein the wind turbine comprises a pump, that is functionally connected to the at least one cooling channel, and a heat exchanger, in particular an external heat exchanger for re-cooling the coolant. The pump pumps the coolant through the cooling circuit. Thus, the coolant is preferably directed to a heat exchanger, where the coolant is cooled and, through the connections, is pumped back into the cooling channel.

Preferably, the external heat exchanger is arranged in such a way that it is cooled by a natural, incoming air flow. Such an external heat exchanger is located in or on the nacelle of the wind turbine, preferably on at least one outer face of the nacelle, or at or in the spinner. Preferably, the external heat exchanger comprises fin tubes or fin-like cooling elements, which have a sufficiently large surface to ensure the required heat release.

Alternatively, an artificial incoming air flow, for example from a fan, can also be used for cooling.

Furthermore, a method for manufacturing a laminated core assembly according to the invention is proposed. The method comprises the following steps:
Arranging the composite material on the laminated pole shoe core,
Arranging the winding around the arranged composite material,
Treating the composite material so that it settles into the recesses of the laminated core and/or the winding,
Curing the composite material,

so that the composite material forms, entirely or partially, an insulating means for the conduction of heat and electrical insulation between the laminated core and the winding. The composite material is wound around the laminated cores while in preheated condition, and subsequently, preferably the entire generator, is immersed for example in resin. Thus, air entrapment is prevented, or at least reduced. The generator and/or the bath in which it is immersed preferably have a temperature of around 120° C.-160° C., in particular around 150° C.

Preferably, the composite material comprises a paper impregnated with resin and/or a non-woven material impregnated with resin. Thus, the flow properties of the resin are improved.

In another preferred embodiment, ceramic particles are added to the composite material. They are preferably added to the resin after or before the composite material is being arranged on the laminated core, preferably they are rubbed in similar to a paste. Thus, air entrapment is prevented, or at least reduced. Or, the ceramic particles are added to the composite material before, in particular together with the matrix.

According to another embodiment, the composite material is cured through heat treatment, preferably through tempering. Alternatively, the composite material could be cured through UV curing.

### BRIEF DESCRIPTION OF THE SEVERAL VIEWS OF THE DRAWINGS

By way of example, the invention is described in more detail below by means of some exemplary embodiments, with reference to the accompanying FIGS..

FIG. 1 shows a simplified illustration of a wind turbine.

FIG. 2 shows an exemplary embodiment of two laminated core assemblies.

FIG. 3 shows a section of FIG. 2.

FIG. 4 shows a sectional view of FIG. 2.

### DETAILED DESCRIPTION

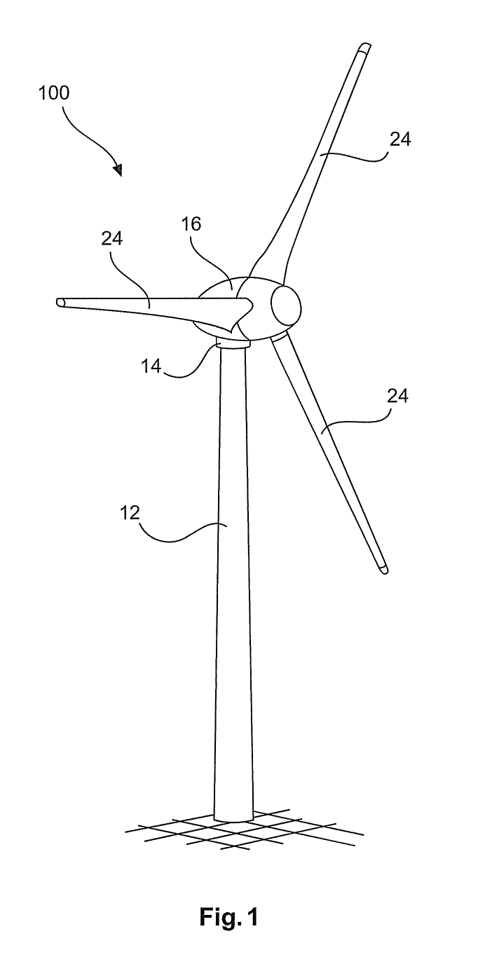

FIG. 1 shows a highly simplified illustration of a wind turbine, which in its entirety is marked with reference number 100. The tower has reference number 12, the nacelle 16 (alternatively, instead of the term nacelle, the term machine housing may be used as well). The nacelle 16 is mounted to the head of the tower by means of a azimuth bearing (not shown) in such a way that wind direction tracking can be realized through azimuth drives (also not shown). The transition between the nacelle 16 and the tower 12 is covered by a nacelle apron 14 and thus protected against adverse weather effects.

The nacelle 16 also contains the hub (also not shown), which the rotor blades 24 are attached to. Through the rotor blades 24, the hub (with the spinner, the front part of the nacelle 16) is brought into rotation. This rotation movement is transmitted to the rotor of the generator so that, in case of sufficient wind velocity, the wind turbine 100 generates electrical energy.

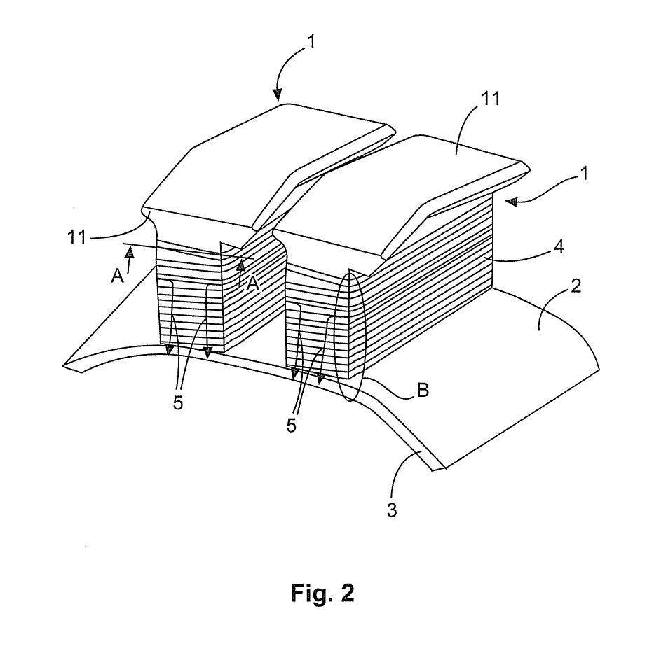

FIG. 2 shows a schematic view of two laminated core assemblies, namely two pole shoe assemblies 1 with respectively one laminated core, namely laminated pole shoe core 11, and respectively one winding 4, which is arranged on a rotor 2, only a section of which is shown. The rotor 2 comprises a bearing ring, which is referred to as rotor belt and supports the laminated pole shoe cores 11. The rotor belt comprises a radially circumferential cooling channel, not shown in this figure. For illustration purposes, the direction of the thermal conduction 5 is marked by arrows. Accordingly, the heat arisen in the winding 4 is conducted into the rotor belt 3 via the laminated pole shoe core 11. The cooling channel arranged in the rotor belt 3 is used for conducting the heat. A coolant, which is part of a closed cooling circuit, flows through the cooling channel. From there, the warmed up coolant is pumped into a heat exchanger and, after the heat exchange, pumped into the cooling channel again.

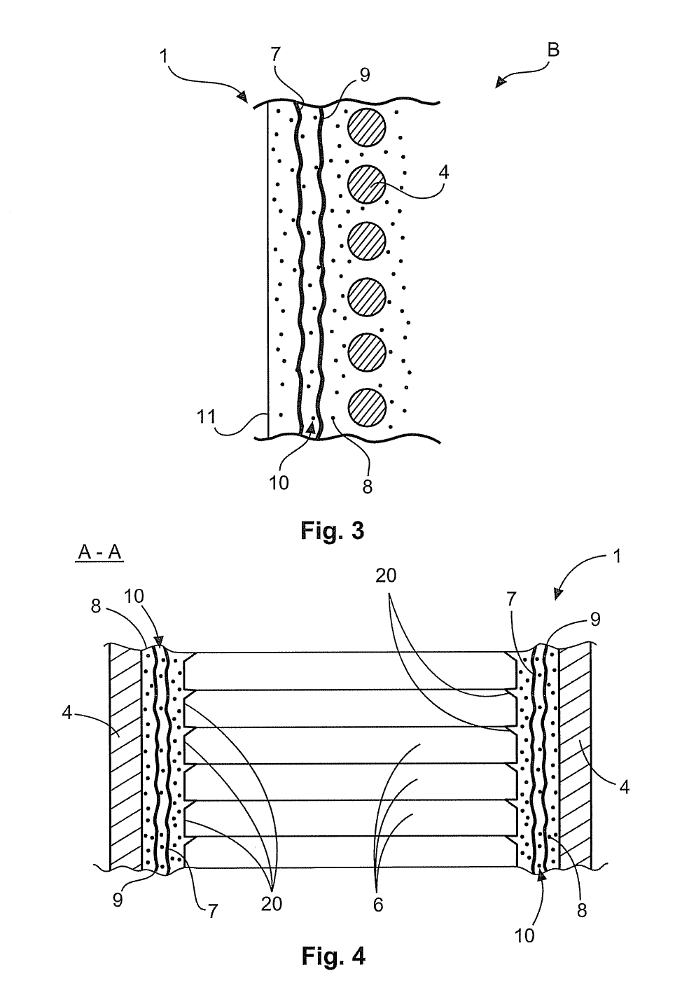

FIG. 3 shows a section of FIG. 2 with reference sign B, which illustrates a magnified section of the pole shoe assembly 1 by magnifying and partially illustrating the area between the laminated pole shoe core 11 and the winding 4. Between the winding 4 and the laminated pole shoe core 11, a composite material 10 is shown as an example of an insulating means or materials, which comprises a paper 7, a non-woven material 9 and a resin 8. The individual components are combined into one unit, which can be installed during the assembly of laminated core assemblies, such as the pole shoe assembly 1, as a covering. It can be seen in this FIG. that the resin 8 settles into the gaps of the winding 4 and thus prevents, or at least reduces, air entrapment. Unevenness of the surface of the laminated pole shoe assembly 11, which is assembled of a number of different laminated pole shoe cores (not shown in the FIG.), are compensated for.

FIG. 4 shows a section of a sectional view of a pole shoe assembly 1. In FIG. 4, the individual laminated pole shoe sheets 6 or respectively lamellas 6 of the laminated pole shoe core 11. In addition, the FIG. shows the winding 4 as well as the paper 7, the non-woven material 9 and the resin 8. Due to the individual lamellas 6, the circumference of the laminated pole shoe core 11—and thus the surface pursuant to the sectional view of FIG. 4—does not have an even surface. Gaps and pores can arise due to unevenness of the edges 20 or due to smaller misalignment of the pole shoe sheets 6, which leads to the risk of air entrapment and therefore to the risk of a bad thermal conductivity. This is why the paper 7 and the non-woven material 9 are used. They both have a high suction power through which an improved capillary action is achieved and a large amount of resin can be absorbed and be provided to the shown place of use to settle into gaps and pores and to prevent or reduce air entrapment. Non-woven material in particular can absorb and provide large amounts of resin.

FIGS. 3 and 4 respectively show a schematic view of sections of FIG. 2. Deviations in the details of FIGS. 2, 3 and 4 may occur.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A laminated core assembly of an electric generator of a gearless wind turbine, the laminated core assembly comprising:
at least one laminated core;
at least one winding arranged around the laminated core; and
one or more electrical insulating means arranged between the laminated core and the winding, wherein the insulating materials are a composite material for conducting heat generated by the winding.

2. the laminated core assembly according to claim 1, wherein the insulating means includes a paper and a resin impregnated layer of material arranged on the paper.

3. The laminated core assembly according to claim 1, wherein the insulating means comprises ceramic particles.

4. The laminated core assembly according to claim 1, wherein the at least one laminated core has a heat sink that at least partially surrounds the laminated core, wherein the heat sink is arranged between the laminated core and the winding.

5. The laminated core assembly according to claim 4, wherein the insulating means are arranged between the winding and the heat sink.

6. The laminated core assembly according to claim 4, wherein the heat sink has connections that are at least partially integrated into the laminated core.

7. An electric generator of a gearless wind turbine, the electric generator comprising:
a rotor that includes a rotor belt;
a stator that includes a stator belt, wherein at least one of the rotor and the stator has at least one laminated core assembly, the laminated core assembly including a composite material that is electrically insulating and thermally conductive; and
a cooling channel that is located in at least one of the rotor belt and the stator belt for transporting a coolant.

8. The electric generator according to claim 7, wherein at least one of the rotor and stator have a plurality of laminated cores, wherein each laminated core has one heat sink that is thermally coupled to the cooling channel.

9. The electric generator according to claim 7 wherein the rotor comprises air cooling.

10. A wind turbine comprising the electric generator according to claim 7, the wind turbine further comprising:
a pump that is functionally connected to the cooling channel; and
a heat exchanger for cooling the coolant.

11. The wind turbine according to claim 10, wherein the heat exchanger is arranged in such a way that it is cooled by incoming air flow.

12. A method for manufacturing a laminated core assembly, the method comprising:
arranging a composite material on a laminated core;
arranging a winding around the composite material;
treating the composite material to cause at least a portion of the composite material to settle into the recesses of at least one of the laminated core and the winding; and
curing the composite material located between the laminated core and the winding, the cured composite material being electrically isolating and thermally conductive, the cured composite material being configured to remove heat from the winding.

13. The method according to claim 12, wherein the composite material comprises at least one of a paper impregnated with resin and a non-woven material impregnated with resin.

14. The method according to claim 12, wherein ceramic particles are added to the composite material.

15. The method according to claim 12, wherein the composite material is cured by heat treatment.

16. The method according to claim 15, wherein the composite material is cured by tempering.

17. The laminated core assembly according to claim 2, wherein the paper is aramid paper.
